(19) United States
(12) Patent Application Publication
(10) Pub. No.: US 2013/0309352 A1
(43) Pub. Date: Nov. 21, 2013

(54) GUM BASE, CHEWING GUM PREPARATION PRODUCED THEREFROM AND METHODS FOR PRODUCTION THEREOF

(71) Applicants: Thomas WIMMER, Burghausen (DE); Jochen DAUTH, Muenchen (DE)

(72) Inventors: Thomas WIMMER, Burghausen (DE); Jochen DAUTH, Muenchen (DE)

(73) Assignee: WACKER CHEMIE AG, Muenchen (DE)

(21) Appl. No.: 13/863,702

(22) Filed: Apr. 16, 2013

(30) Foreign Application Priority Data
May 15, 2012 (DE) 10 2012 208 131.3

(51) Int. Cl. A23G 4/08

(52) U.S. Cl. CPC A23G 4/08
USPC 426/4

(57) ABSTRACT

The invention relates to a gum base which, in comparison with known gum bases, has an improved aroma, taste and improved oxidation stability, has only low stickiness, and in addition is simple to process. It is a homogeneous composition containing 15-45% by weight of polyvinyl acetate, 10-30% by weight of vinyl laurate-vinyl acetate copolymers, 15-45% by weight of fillers, 5-30% by weight of waxes or fats, 1-10% by weight of plasticizers and 1-10% by weight of emulsifiers.

### BACKGROUND OF THE INVENTION

The invention relates to a gum base, to a chewing gum preparation produced therefrom, and also to methods for production thereof.

Chewing gum preparations usually consist of a water-insoluble part, termed the gum base, and a water-soluble part (sugars or polyols/sugar alcohols), which, in a lesser amount, contains flavorings, sweeteners and optionally dyes or antioxidants.

Typically, gum base formulations contain elastomers (such as, for example, polyisobutylene, butyl rubber, styrene-butadiene rubber (SBR) or natural rubber), polyvinyl acetate, optionally vinyl acetate-vinyl laurate copolymers, polyterpenes or esters of colophonium resins, fillers, fats (partially hardened vegetable fats) or waxes (paraffin waxes, microcrystalline waxes) and also emulsifiers.

U.S. Pat. No. 4,876,095 and U.S. Pat. No. 5,110,607 disclose gum bases that contain elastomers such as SBR, polyisobutylene or butyl rubber, but no colophonium resins or polyterpenes.

In U.S. Pat. No. 5,173,317, polyvinyl acetate-free gum bases are described which contain vinyl acetate-vinyl laurate copolymers as the elastomers predominantly used. These masses contain, in addition, colophonium resin derivatives or polyterpenes.

U.S. Pat. No. 5,116,626 describes a transparent gum base/chewing gum preparation consisting virtually exclusively of polyvinyl acetate, polyisobutylene, vinyl laurate-vinyl acetate copolymers and a plasticizer.

US2011/0293777 discloses formulations which contain vinyl laurate-vinyl acetate copolymers, polyvinyl acetate, colophonium resin derivatives, fillers, plasticizers and emulsifiers.

DE 102011082981 describes a gum base and a chewing gum preparation based on this gum base which are less sticky than known gum bases/chewing gum preparations. This gum base is a homogeneous composition consisting of polyvinyl acetate in an amount of 25-90% by weight, vinyl laurate-vinyl acetate copolymer in an amount of 5-70% by weight, and also a plasticizer in an amount of 1%-15% by weight, in each case based on the total weight of the composition.

It is an object of the present invention to provide a gum base which, in comparison with known gum bases, has an improved aroma, taste and improved oxidation stability, has only low stickiness, and in addition is simple to process.

### DESCRIPTION OF THE INVENTION

The object is achieved by a homogeneous composition consisting of 15-45% by weight of polyvinyl acetate, 10-30% by weight of vinyl laurate-vinyl acetate copolymers, 15-45% by weight of fillers, 5-30% by weight of waxes or fats, 1-10% by weight of plasticizers and 1-10% by weight of emulsifiers.

Preferably, the homogeneous composition consists of 20-35% by weight of polyvinyl acetate (PVAc) and of 12-25% by weight of vinyl laurate-vinyl acetate copolymer (VL/VA copolymer). Fillers are preferably present in an amount of 20-30% by weight, waxes or fats preferably in an amount of 10-20% by weight, plasticizers preferably in an amount of 2-8% by weight, and emulsifiers preferably in an amount of 2-8% by weight.

All percentages by weight stated are based on the total weight of the respective composition. The usage amounts stated in % by weight of the components of a formulation add up in each case to 100% by weight.

The homogeneous composition according to the invention contains no elastomers, no colophonium resin derivatives and no polyterpenes. It thus avoids the disadvantages associated with these components.

Elastomers, among which, within the meaning of the invention, are understood to be styrene-butadiene rubber, polyisobutylene, butyl rubber, natural rubbers, such as, for example, chicle (usually based on cis- or trans-1,4-polyisoprenes), have the disadvantage that handling and processing is complex. In order to achieve a homogeneous gum base, the (generally non-meltable) elastomers must be dispersed with the remaining ingredients of a gum base in complex time-intensive processes, under high shearing forces.

A disadvantage of the polyterpenes or colophonium resin derivatives usually used is the unpleasant taste and aroma thereof. In addition, these products are unstable with respect to oxidation, which leads to reduced keeping quality of the products themselves and of the formulations produced therefrom.

All components of the composition according to the invention, except for the filler, melt at processing temperature and may therefore be mixed and processed more readily than known gum bases.

Preference is given to polyvinyl acetates having a weight-average molecular weight Mw from 10,000 to 60,000, particularly preferably 15,000 to 50,000. The weight-average molecular weight Mw was determined using size exclusion chromatography (SEC) against a polystyrene standard, in THF, at 40° C., flow rate 1.2 ml/min. Mixtures of polyvinyl acetates having differing molecular weight can also be used.

The vinyl laurate-vinyl acetate copolymer preferably has a weight-average molecular weight Mw from 50,000 to 600,000, particularly preferably 100,000 to 400,000. The vinyl laurate-vinyl acetate copolymer preferably contains 15 to 60% by weight of vinyl laurate units and 40 to 85% by weight of vinyl acetate units, particularly preferably 35-45% by weight of vinyl laurate units and 55 to 65% by weight of vinyl acetate units. A plurality of vinyl laurate-vinyl acetate copolymers of different copolymer composition and/or different molecular weight can also be used.

The fillers used in the gum base according to the invention are preferably selected from the group calcium carbonate, magnesium carbonate, talcum and dicalcium phosphate. Preference is given to calcium carbonate or talcum.

Waxes that are preferably used are paraffin waxes, microcrystalline waxes, polyethylene waxes or natural waxes such as beeswax or carnauba wax. Fats which come into consideration are animal fats such as, e.g., tallow and lard, and also vegetable fats, e.g. cocoa butter, soybean oil, cotton seed oil, which can also be hardened. Particular preference is given to microcrystalline waxes and hardened vegetable fats. Microcrystalline waxes are taken to mean hydrocarbons that are preferably solid at 20° C. and contain a higher proportion of branched alkanes compared with paraffin waxes.

The plasticizer is preferably selected from the group diacetin and triacetin. Particular preference is given to triacetin.

The emulsifiers used in the gum base according to the invention are preferably selected from the group monoglycerides, diglycerides, acetem, glycerol monostearate, lecithin. Particular preference is given to acetem and glycerol monostearate. Mixtures of a plurality of emulsifiers can also be used.

The homogeneous composition according to the invention is preferably suitable as gum base, and the invention therefore also relates to the use of a composition according to the invention as gum base. The gum base according to the invention and also chewing gum preparations produced therefrom have an improved release of flavorings, with respect to known gum bases/chewing gum preparations.

The gum base according to the invention can be produced by a method usual for masses of this type, generally a kneading method. Production can proceed continuously, e.g., in an extruder, or discontinuously, e.g., in a twin-Z kneader. It preferably proceeds at a temperature of 80-130° C., preferably 90-120° C., over a time period of 30 to 100 minutes.

Polyvinyl acetates suitable for this purpose and suitable vinyl laurate-vinyl acetate copolymers are commercially available, for example the VINNAPAS® solid resins from Wacker Chemie AG. The polyvinyl acetate component and the vinyl laurate-vinyl acetate copolymer component can be produced in a known manner using mass or solution polymerization. A suitable method is described, for example, in EP 1352914 B1. For this purpose, the corresponding monomers are polymerized in the presence of initiators such as peroxide or azo initiators, optionally in a usually alcoholic solvent, and optionally in the presence of regulators, at a temperature of generally 40° C. to 140° C., and optionally solvent and regulator and also residual monomer are distilled off.

During the production of the gum base according to the invention, preferably polyvinyl acetate and vinyl laurate-vinyl acetate copolymers are mixed at the start and the remaining ingredients are then added.

Production of a chewing gum according to the invention from the gum base usually proceeds at approximately 60° C. with addition of sugar, syrup, flavorings and optionally dyes, fruit acids, sweeteners, moisture-retention agents. Sugar-free chewing gum is produced similarly from gum base, polyols (sugar alcohol, also termed bulk sweetener), flavorings and optionally dyes, fruit acids, sweeteners, moisture-retention agents. Addition proceeds in amounts such that the composition stated hereinafter is obtained.

The gum base according to the invention is optionally heated to 40-60° C. and mixed with the other chewing gum ingredients at 45-65° C. to form a dough. This can be carried out, for example, in a heatable twin-Z kneader or in an extruder. Then, the chewing gum mass is shaped by usual methods. Continuous methods known to those skilled in the art such as extrusion, co-extrusion, rolling or cutting serve for shaping. Possible shapes which come into consideration are strips, slabs, pellets, belts or hollow spheres.

The resultant chewing gum according to the invention contains the composition according to the invention and also sugar or syrup, flavorings and optionally dyes, fruit acids, sweeteners, moisture-retention agents or polyols, flavorings, sweeteners and optionally dyes, fruit acids and moisture-retention agents.

The chewing gum preferably consists of 13-35% by weight of gum base according to the invention, 62-85% by weight of one or more polyols, and also 1-3% by weight of usual flavorings, and optionally up to 3% of moisture-retention agents (e.g. glycerol), optionally fruit acids (e.g. citric acid, malic acid, tartaric acid) up to 1.5% by weight, and optionally sweeteners (acesulfame, aspartame, aspartame-acesulfame salt, cyclamate, saccharin, sucralose, thaumatin, neohesperidin, neotame, steviosides) up to 0.5% by weight.

The polyols are preferably sorbitol, mannitol, maltitol, isomalt, xylitol, erythritol, or a mixture of these compounds. The polyols are preferably present in solid form or as a syrup having a solids content greater than 50% by weight.

The examples hereinafter serve for further illustration of the invention:

### Example 1

### Production of a Gum Base

In a heatable twin-Z kneader, 320 g of homopolymeric PVAc (commercially available from Wacker Chemie AG under the name VINNAPAS B 1.5 sp; Mw 15,000) were melted at 120° C. together with 200 g of vinyl acetate-vinyl laurate copolymer (monomer ratio weight: 60:40; commercially available from Wacker Chemie AG under the name VINNAPAS B 500/40 VL) and mixed with 80 g of triacetin.

Then, at 100° C., 200 g of talcum, 130 g of microcrystalline wax (from Paramelt), 20 g of vegetable fat, 25 g of glycerol monostearate and 25 g of acetem (from Danisco) are added. After a total mixing time of 40 minutes, the gum base is removed from the kneader and cooled to room temperature.

### Example 2

### Production of a Gum Base

In a heatable twin-Z kneader, 230 g of homopolymeric PVAc (commercially available from Wacker Chemie AG under the name VINNAPAS B 5 sp; Mw 25,000) were melted at 120° C. together with 145 g of vinyl acetate-vinyl laurate copolymer (monomer ratio weight: 60:40; commercially available from Wacker Chemie AG under the name VINNAPAS B 500/40 VL) and mixed with 55 g of triacetin.

Then, at 100° C., 420 g of talcum, 100 g of microcrystalline wax (from Paramelt), 10 g of vegetable fat, 15 g of glycerol monostearate and 25 g of acetem (from Danisco) are added. After a total mixing time of 45 minutes, the gum base is taken out of the kneader and cooled to room temperature.

### Example 3

### Production of a Gum Base

In a heatable twin-Z kneader, 320 g of homopolymeric PVAc (commercially available from Wacker Chemie AG under the name VINNAPAS B 1.5 sp; Mw 15,000) were melted at 120° C. together with 200 g of vinyl acetate-vinyl laurate copolymer (monomer ratio weight: 80:20; commercially available from Wacker Chemie AG under the name VINNAPAS B 500/20 VL) and mixed with 80 g of triacetin.

Then, at 100° C., 200 g of talcum, 100 g of microcrystalline wax (from Paramelt), 30 g of vegetable fat, 30 g of glycerol monostearate and 40 g of acetem (from Danisco) are added. After a total mixing time of 40 minutes, the gum base is taken out of the kneader and cooled to room temperature.

### Example 4

### Production of a Gum Base

In a heatable twin-Z kneader, 280 g of homopolymeric PVAc (commercially available from Wacker Chemie AG under the name VINNAPAS B 1.5 sp; Mw 15,000) were melted at 120° C. together with 120 g of vinyl acetate-vinyl laurate copolymer (monomer ratio weight: 80:20; commercially available from Wacker Chemie AG under the name VINNAPAS B 500/20 VL) and mixed with 120 g of vinyl acetate-vinyl laurate copolymer (monomer ratio weight: 60:40; commercially available from Wacker Chemie AG under the name VINNAPAS B 500/40 VL). After kneading, 50 g of triacetin are added. Then, at 90° C., 230 g of talcum, 100 g of microcrystalline wax (from Paramelt), 30 g of vegetable fat, 30 g of glycerol monostearate and 40 g of acetem (from Danisco) are added. After a total mixing time of 40 minutes, the gum base is taken out of the kneader and cooled to room temperature.

### Example 5

### Production of a Gum Base

In a heatable twin-Z kneader, 330 g of homopolymeric PVAc (commercially available from Wacker Chemie AG under the name VINNAPAS B 30 sp; Mw 50,000) were melted at 130° C. together with 240 g of vinyl acetate-vinyl laurate copolymer (monomer ratio weight: 60:40; mean molecular weight of 100,000 measured by SEC) and mixed with 40 g of triacetin. Then, at 95° C., 220 g of calcium carbonate, 70 g of microcrystalline wax (from Paramelt), 60 g of vegetable fat, 20 g of glycerol monostearate and 20 g of acetem (from Danisco) are added. After a total mixing time of 50 minutes, the gum base is taken out of the kneader and cooled to room temperature.

### Example 6

### Production of a Sugar-Free Chewing Gum

In a heatable twin-Z kneader, at 60-80° C., a chewing gum mass was produced from the ingredients in tab. 1. In a laboratory roller-cutting instrument, chewing gum strips were produced therefrom of dimensions 19 mm×74 mm.

TABLE 1

| | |
|---|---|
| Gum base of Example 1 | 320 g |
| Sorbitol | 435 g |
| Lycasin (maltitol syrup) | 63 g |
| Xylitol | 160 g |
| Aspartame | 2 g |
| Peppermint oil | 15 g |
| Glycerol | 5 g |

### Example 7

### Production of a Sugar-containing Chewing Gum

In a heatable twin-Z kneader, at 60-80° C., a chewing gum mass was produced from the ingredients in tab. 1. In a laboratory roller-cutting instrument, chewing gum strips were produced therefrom of dimensions 19 mm×74 mm.

TABLE 2

| | |
|---|---|
| Gum base of Example 3 | 200 g |
| Glucose syrup 45° | 160 g |
| Sugar | 461 g |
| Glycerol | 160 g |
| Aspartame | 1 g |
| Orange oil | 10 g |
| Citric acid | 8 g |

What is claimed is:

1. A homogeneous composition comprising 15-45% by weight of polyvinyl acetate, 10-30% by weight of vinyl laurate-vinyl acetate copolymers, 15-45% by weight of fillers, 5-30% by weight of waxes or fats, 1-10% by weight of plasticizers and 1-10% by weight of emulsifiers.

2. The homogeneous composition as claimed in claim 1, comprising 20-35% by weight of polyvinyl acetate, 12-25% by weight of vinyl laurate-vinyl acetate copolymer, 20-30% by weight of fillers, 10-20% by weight of waxes or fats, 2-8% by weight of plasticizers and 2-8% by weight of emulsifiers.

3. The homogeneous composition as claimed in claim 1, wherein the polyvinyl acetate has a weight-average molecular weight Mw from 10,000 to 60,000, and the vinyl acetate-vinyl laurate copolymer has a weight-average molecular weight Mw from 50,000 to 600,000.

4. The homogeneous composition as claimed in claim 1, wherein: (a) the fillers are selected from the group consisting of calcium carbonate, magnesium carbonate, talcum and dicalcium phosphate; and/or (b) the waxes are selected from the group consisting of paraffin waxes, microcrystalline waxes, polyethylene waxes and natural waxes; and/or (c) the fats are selected from the group consisting of animal fats and vegetable fats; and/or (d) the plasticizer is selected from the group consisting of diacetin and triacetin; and/or (e) the emulsifiers are selected from the group consisting of acetem and glycerol monostearate.

5. A method for producing a homogeneous composition as claimed in claim 1 by mixing together the polyvinyl acetate, vinyl acetate-vinyl laurate copolymer, filler, wax or fat, plasticizer and emulsifier in a discontinuous or continuous method at a temperature of 80-130° C. over a time period of 30 to 100 minutes.

6. A chewing gum comprising the composition as claimed in claim 1 and also sugar or syrup, flavorings and optionally dyes, fruit acids, sweeteners, moisture-retention agents or polyols, flavorings, sweeteners and optionally dyes, fruit acids and moisture-retention agents.

7. A chewing gum comprising 13-35% by weight of a composition as claimed in claim 1, 62-85% by weight of one or more polyols, 1-3% by weight of flavorings, optionally up to 3% by weight of moisture-retention agents and optionally up to 1.5% by weight of fruit acids and optionally up to 0.5% by weight of sweeteners.

8. A method for producing a chewing gum, said method comprising mixing at approximately 60° C. a homogeneous composition of claim 1 with polyols or sugar and syrup and flavorings, and optionally dyes, fruit acids, sweeteners and moisture-retention agents.

9. A method for producing a gum base, said method comprising use of a composition as claimed in claim 1 as a gum base.

10. The homogeneous composition as claimed in claim 2, wherein the polyvinyl acetate has a weight-average molecular weight Mw from 10,000 to 60,000, and the vinyl acetate-vinyl laurate copolymer has a weight-average molecular weight Mw from 50,000 to 600,000.

11. The homogeneous composition as claimed in claim 10, wherein: (a) the fillers are selected from the group consisting of calcium carbonate, magnesium carbonate, talcum and dicalcium phosphate; and/or (b) the waxes are selected from the group consisting of paraffin waxes, microcrystalline waxes, polyethylene waxes and natural waxes; and/or (c) the fats are selected from the group consisting of animal fats and vegetable fats; and/or (d) the plasticizer is selected from the group consisting of diacetin and triacetin; and/or (e) the emulsifiers are selected from the group consisting of acetem and glycerol monostearate.

12. A method for producing a homogeneous composition as claimed in claim 11 by mixing together the polyvinyl acetate, vinyl acetate-vinyl laurate copolymer, filler, wax or fat, plasticizer and emulsifier in a discontinuous or continuous method at a temperature of 80-130° C. over a time period of 30 to 100 minutes.

13. A chewing gum comprising the composition as claimed in claim 11 and also sugar or syrup, flavorings and optionally dyes, fruit acids, sweeteners, moisture-retention agents or polyols, flavorings, sweeteners and optionally dyes, fruit acids and moisture-retention agents.

14. A chewing gum comprising 13-35% by weight of the composition as claimed in claim 11, 62-85% by weight of one or more polyols, 1-3% by weight of flavorings, optionally up to 3% by weight of moisture-retention agents and optionally up to 1.5% by weight of fruit acids and optionally up to 0.5% by weight of sweeteners.

15. A method for producing a chewing gum, said method comprising mixing at approximately 60° C. a homogeneous composition of claim 11 with polyols or sugar and syrup and flavorings, and optionally dyes, fruit acids, sweeteners and moisture-retention agents.

16. A method for producing a gum base, said method comprising use of a composition as claimed in claim 11 as a gum base.
